(19) United States
(12) Patent Application Publication
(10) Pub. No.: US 2012/0019816 A1
(43) Pub. Date: Jan. 26, 2012

(54) DEFECT INSPECTION METHOD AND DEFECT INSPECTION APPARATUS

(75) Inventors: Yukihiro Shibata, Fujisawa (JP); Toshihiko Nakata, Hiratsuka (JP); Toshifumi Honda, Yokohama (JP); Yasuhiro Yoshitake, Yokohama (JP)

(73) Assignee: HITACHI HIGH-TECHNOLOGIES CORPORATION, Tokyo (JP)

(21) Appl. No.: 13/145,138

(22) PCT Filed: Jan. 6, 2010
(86) PCT No.: PCT/JP2010/000045

§ 371 Date: Oct. 11, 2011

(30) Foreign Application Priority Data
Feb. 18, 2009 (JP) 2009-035167

(51) Int. Cl. G01N 21/88

(52) U.S. Cl. 356/237.5

(57) ABSTRACT

The present invention provides a spatial filtering technology for exposing a defect image independently of polarization properties of defect scattered light, a defect inspection method for increasing a defect capture rate by suppressing the brightness saturation of a normal pattern, and a defect inspection apparatus that uses the defect inspection method. An array of spatial filters is disposed in one or more optical paths, which are obtained by polarizing and splitting a detection optical path, to filter diffracted light and scattered light emitted from the normal pattern. An image whose brightness saturation is suppressed is obtained by controlling an illumination light amount and/or detection efficiency during image detection in accordance with the amount of scattered light from the normal pattern.

### TECHNICAL FIELD

The present invention relates to a defect inspection method and a defect inspection apparatus. For example, the invention relates to a defect inspection method of inspecting, for instance, for defects and foreign matter in a fine pattern that is formed on a substrate through a thin-film process, which is typically included in a semiconductor manufacturing process or a flat-panel display manufacturing process. The invention also relates to a defect inspection apparatus that uses the above defect inspection method.

### BACKGROUND ART

A conventional semiconductor inspection apparatus disclosed, for instance, in International Publication No. WO 2003/083560 incorporates a dark-field detection optical system that obliquely illuminates a wafer surface and detects scattered light above the wafer surface. The optical system includes a spatial filter that is disposed at a rear focal position of an objective lens (at an exit pupil position) to shield against diffracted light from a periodic pattern. A configuration including a liquid-crystal filter adapted to ultraviolet rays is indicated as the spatial filter.

### RELATED ART LITERATURE

### Patent Document

Patent Document 1: International Publication No. WO 2003/083560

### SUMMARY OF THE INVENTION

### Problem to be Solved by the Invention

Various patterns are formed on a semiconductor wafer. Various types of defects may be encountered depending on the cause of defect generation. When a liquid-crystal filter is used as the spatial filter, it is necessary to convert scattered light into linearly-polarized light by filtering and electrically control an array of liquid crystals to cause optical rotation. The transmittance of light transmitted through a polarizing plate disposed on the image plane side can be controlled in accordance with the amount of optical rotation. However, the polarization of the scattered light varies with the shape, structure, and material of the patterns and defects. Therefore, when filtering is performed to obtain linearly-polarized light on the object side (wafer side) of a liquid crystal, defect detection cannot be achieved as defect scattered light is blocked in a situation where it is polarized in a direction orthogonal to a filter transmission axis.

Further, if there is a boundary between two portions that differ in pattern periodicity or pitch in a stage scanning direction when a TDI (Time Delay Integration) image sensor is used to detect an image, an appropriate light shielding scheme cannot be set at the boundary no matter whether the light shielding scheme of the spatial filter is rapidly changed.

Moreover, the scattered light greatly varies with the size, orientation, and periodicity of the patterns and defects. In particular when microscopic defects are to be detected, it is necessary to raise an illumination light intensity setting. However, a light amount greater than the dynamic range of the image sensor is detected within a normal pattern. Consequently, image saturation occurs so that defect inspection will be substantially left undone.

An object of the present invention is to provide a defect inspection method for detecting a wide variety of target defects existing on a wafer with a high sensitivity and at a high capture rate. Another object is to provide a defect inspection apparatus that uses the above defect inspection method.

### Means for Solving the Problem

The present invention relates to a defect inspection apparatus for detecting a defect on a surface of a sample on which a pattern is formed. The defect inspection apparatus includes an illumination optical system, light capture means, polarizing-and-splitting means, and light shielding means. The illumination optical system includes a light source section, which emits light, and an illumination section, which irradiates the sample with the light at a predetermined angle with respect to a normal extending from the sample surface. The light capture means captures scattered light or diffracted light emitted from an area illuminated by the light incident on the sample. The polarizing-and-splitting means receives the light captured by the light capture means, and polarizes and splits the light into a first direction and a second direction orthogonal to the first direction. The light shielding means blocks part of the split light in one or more optical paths of the polarized and split light.

The present invention also relates to a defect inspection apparatus for detecting a defect on a surface of a sample on which a pattern is formed. The defect inspection apparatus includes an illumination optical system, an objective lens, image detection means, and an image processing section. The illumination optical system includes a light source section, which emits light, and an illumination section, which irradiates the sample with the light at a predetermined angle with respect to a normal extending from the sample surface. The objective lens captures scattered light or diffracted light emitted from an area illuminated by the light incident on the sample. The image detection means detects an image with an image sensor that is disposed on an imaging plane formed by the objective lens and provided with an element capable of modulating a light amount on an individual pixel basis. The image processing section performs a comparison process on an image feature amount obtained from the imaging plane to identify a defect candidate.

The present invention also relates to a defect inspection apparatus for detecting a defect on a surface of a sample on which a pattern is formed. The defect inspection apparatus includes a measurement section, an illumination section, an objective lens, image detection means, and an image processing section. The measurement section irradiates the sample with light to preliminarily measure the position of the sample and the amount of light scattered from the sample. The illumination section includes a calculation section for calculating an illumination light amount at each sample position from the measured values, subjects the light to intensity modulation in accordance with the position-specific illumination light amount, and linearly illuminates the sample with the intensity-modulated light at an oblique angle with respect to a normal extending from the sample surface. The objective lens captures scattered light or diffracted light emitted from an area illuminated by the light incident on the sample. The image detection means detects an image with an image sensor that is disposed on an imaging plane formed by the objective lens. The image processing section performs a comparison process on a feature amount of the image obtained from the imaging plane to identify a defect candidate.

The present invention also relates to a defect inspection method for detecting a defect on a surface of a sample on which a pattern is formed. The defect inspection method includes the steps of: illuminating the sample with linear illumination light at an oblique angle from a normal extending from the sample while scanning the sample in a horizontal plane; allowing an objective lens to capture scattered light and diffracted light emitted from an area illuminated by the illumination light incident on the sample; permitting polarizing-and-splitting means to split the captured light into a plurality of optical paths; blocking part of the captured light with an array of spatial modulators disposed in one or more of the optical paths of the split light; forming an image on an imaging plane of each optical path of the split light that is not blocked by the spatial modulators; allowing an image sensor disposed on each imaging plane to detect a plurality of images at approximately the same time; and performing a comparison process on a feature amount obtained from the detected images to identify a defect candidate.

The present invention also relates to a defect inspection method for detecting a defect on a surface of a sample on which a pattern is formed. The defect inspection method provides a function for preliminarily measuring the position of the sample and the amount of light scattered from the sample, and includes the steps of: linearly illuminating the sample, at an oblique angle from a normal extending from the sample, with light that is intensity-modulated in accordance with the measured sample position and scattered light amount; allowing an objective lens to capture scattered light and diffracted light emitted from an illuminated area and form an image on an imaging plane; detecting the image with an image sensor disposed on the imaging plane; and performing a comparison process on a feature amount obtained from the image to identify a defect candidate.

The present invention also relates to a defect inspection method for detecting a defect on a surface of a sample on which a pattern is formed. The defect inspection method includes the steps of: placing the sample on a stage; irradiating the sample with light; prescanning the sample to preliminarily measure the position of the sample and the amount of light scattered from the sample while gradually moving the stage; determining the amount of illumination light to be incident on the sample in accordance with the measured sample position and scattered light amount; and adjusting the amount of detected scattered light or diffracted light emitted from an area that is illuminated by the light incident on the sample in accordance with the illumination light amount.

### Advantages of the Invention

According to the present invention, an image that exposes defects and is favorable for sensitivity enhancement can be obtained by appropriately blocking scattered light and diffracted light from a wide variety of normal patterns existing on a wafer and efficiently detecting scattered light from inspection target defects. In addition, the brightness saturation of a normal pattern image, which emits a large amount of scattered light, can be reduced even when the intensity of illumination light is increased to obtain adequate scattered light from microscopic defects. This makes it possible to provide an increased defect capture rate.

### BRIEF DESCRIPTION OF DRAWINGS

FIG. 1 is a diagram illustrating the configuration of an optical system for a defect inspection apparatus according to a first embodiment of the present invention.

FIGS. 2(a) and 2(b) are diagrams illustrating the configuration of a confocal detection system.

FIGS. 3(a) to 3(d) are diagrams illustrating an illumination intensity modulation illumination scheme.

FIG. 4 is a diagram illustrating the configuration of a transmission spatial filter.

FIGS. 5(a) to 5(c) are diagrams illustrating the configuration of a transmission spatial filter.

FIG. 6 is a diagram illustrating the configuration of an optical system.

FIGS. 7(a) to 7(e) are diagrams illustrating the configuration of a reflection spatial filter.

FIGS. 8(a) to 8(c) are diagrams illustrating the configuration of a detection polarization control image sensor.

FIG. 9 is a flowchart illustrating inspection condition setup based on detection transmittance control.

FIG. 10 is a conceptual diagram illustrating a detection transmittance setting.

### BEST MODE FOR CARRYING OUT THE INVENTION

Embodiments of the present invention will now be described in detail with reference to the accompanying drawings.

### First Embodiment

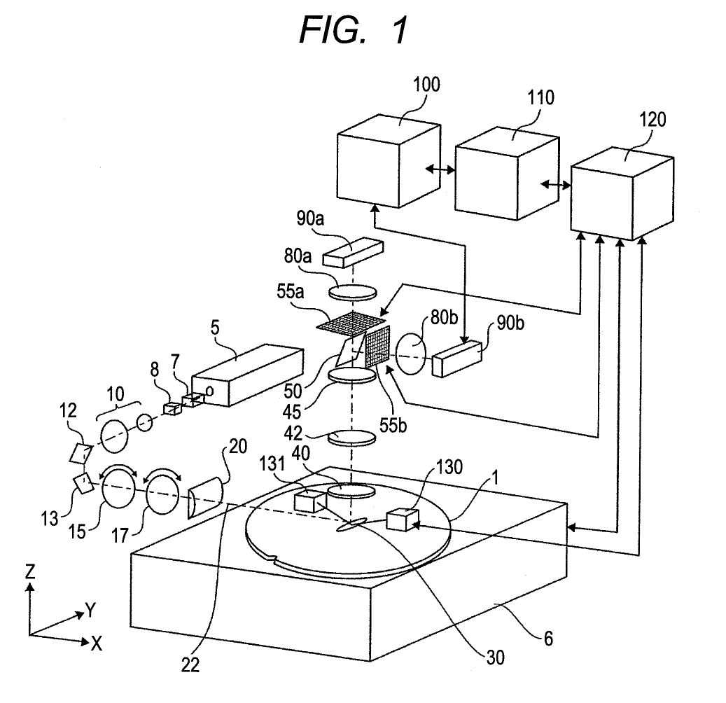

FIG. 1 shows the configuration of a semiconductor wafer defect inspection apparatus according to the present invention. A wafer 1 is placed on a stage 6 so that θ alignment is effected in the direction of stage scanning with respect to a pattern formed on the wafer 1. As regards a dark-field image of the wafer 1, an image of scattered light is continuously detected while the stage 6 is scanned in the X direction at a constant rate. An illumination optical system is positioned obliquely relative to the wafer 1 and used to provide the wafer 1 with linear illumination 30. A laser 5 is used as a light source for the illumination optical system 5′. Candidate lasers have an emission wavelength ranging from DUV (Deep Ultraviolet) light to visible light, including second harmonic 532 nm YAG laser light, third harmonic 355 nm laser light or fourth harmonic 266 nm laser light, and 199 nm laser light.

Further, multi-wavelength lasers, which emit a plurality of wavelengths, and lamps are also candidates. Candidate lamps are mercury lamps and mercury-xenon lamps that emit d-rays (588 nm), e-rays (546 nm), g-rays (436 nm), h-rays (405 nm), or i-rays (365 nm). Laser light 22 emitted from the laser 5 is incident on an electrooptical element 7 (e.g., LiNbO₃ or PLZT [(Pb,La)(Zr,Ti)O₃]) that exercises electrical control to provide polarization in a predetermined direction. A magnetooptical element, which includes, for instance, garnet film, may be used in place of the electrooptical element. When the direction of polarization is controlled as described above, the amount of light transmitted through a PBS (Polarizing Beam Splitter) 50 is reduced to a predetermined value. The resulting light is then incident on a beam expander 10 to enlarge the diameter of a beam. Mirrors 12, 13 are used to reflect the beam toward the wafer 1. A half-wavelength plate 15 and a quarter-wavelength plate 17, which are both rotatable, are then used to place the reflected beam in a predetermined polarization state.

For example, the wafer 1 may be subjected to S-polarization, P-polarization, linear polarization, which provides oscillation at an angle intermediate between S-polarization and P-polarization, or clockwise or counterclockwise elliptic (circular) polarization. A cylindrical lens 20 is disposed so that the illumination light 22 incident on the wafer 1 is thin in the X direction and long in the Y direction. Scattered light emitted from patterns and defects on the wafer is partly transmitted into an NA (Numerical Aperture) of an objective lens 40, captured by the objective lens 40, and introduced into a detection optical system. Lenses 42, 45 and the polarizing beam splitter 50 are disposed in the detection optical system. An image conjugate to a pupil of the objective lens 40 (Fourier transform plane) is formed in each optical path obtained when the light is split into orthogonal oscillation directions by the polarizing beam splitter 50. Spatial modulators 55a, 55b are both disposed at a pupil image position to block a particular beam of scattered light or diffracted light. The light transmitted through the spatial modulators 55a, 55b travels through imaging lenses 80a, 80b to form scattered images on image sensors 90a, 90b, respectively. Images detected by the image sensors 80a, 80b are input into an image processing section 100 and compared against an image having the same pattern in terms of design (e.g., the image of a neighboring die) to detect a defect. Defect information, such as the coordinates, size, and brightness of the detected defect, is sent to an operation section 110 so that a user of the defect inspection apparatus can display defect information, such as a defect map of the wafer, and output defect information data.

The operation section 110 is also capable of issuing operating instructions for the defect inspection apparatus. It issues operating instructions to a mechanism control section 120 and allows the mechanism control section 120 to control the operations of the stage 6 and optical parts. A microshutter array or liquid-crystal filter that utilizes the electrooptical effect of a birefringent element (e.g., LiNbO₃ or PLZT [(Pb,La)(Zr,Ti)O₃]) or a one- or two-dimensional array filter that utilizes MEMS (Micro Electro Mechanical Systems) may be used as the spatial modulators 55a, 55b for use in the optical system. As these devices can be electrically controlled to provide highs-speed switching between light transmission and light shielding, it is possible to switch to an appropriate filtering pattern during inspection in accordance with the pitch and shape of a pattern on the wafer 1. Further, to align a surface layer of the wafer 1 with a focal position of the objective lens 40, it is necessary to detect the height of the wafer and control the height of the wafer 1 with the Z stage 6. An optical lever method is used for wafer height detection. A height detection illumination system 131 and a wafer height detection section 130 are disposed. The height detection illumination system 131 illuminates the wafer 1 with slit light. The wafer height detection section 130 detects the slit light reflected from the wafer 1 and determines the height of the wafer from the position of a slit image. The difference between the height of the wafer 1 and the focal position of the objective lens 40 is determined. If the difference indicates an unacceptable defocus, the mechanism control section 120 instructs the Z stage 6 to move the wafer 1 to the focal position.

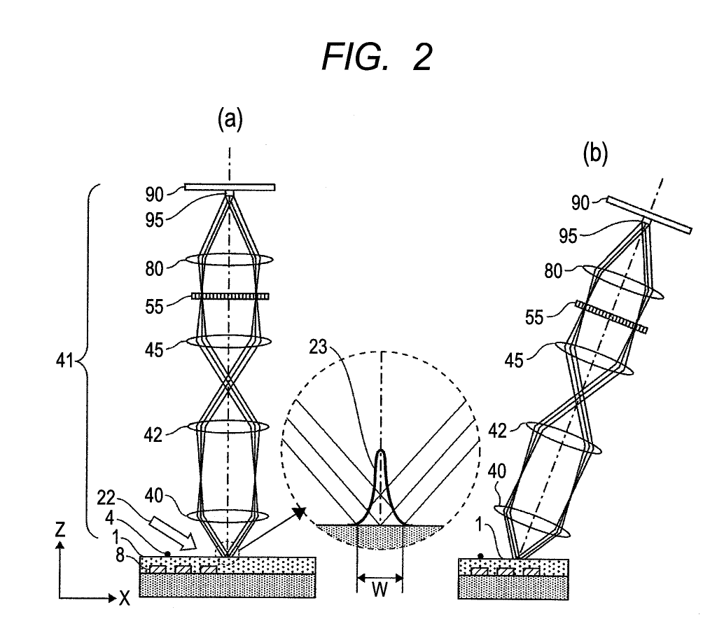

The above-described configuration is employed to detect defects on the wafer 1. However, it should be noted that the wafer 1 has a multilayer wiring structure in which multiple wiring layers are stacked one on top of another. In some cases, a main purpose of inspection is to detect defects in the surface layer, and the detection of lower-layer patterns and defects is not intended. FIGS. 2(a) and 2(b) show an optical path of a dark-field confocal detection system that inhibits the detection of lower-layer defects. The wafer 1 is thin-line illuminated with the illumination light 22 that is W in width and oriented in the X direction. If there is a pattern, defect, or other scatterer in such an illuminated area, the objective lens 40 captures scattered light. The lenses 42, 45 form a Fourier transform image of the wafer 1, and spatial modulators 55 are disposed at the position of the Fourier transform image. The light derived from spatial filtering by the spatial modulators 55 is transmitted through an imaging lens 80 to form a scattered image on an image sensor 90. The image sensor 90 is a one-dimensional array CCD (Charge Coupled Device) camera or CMOS (Complementary Metal Oxide Semiconductor) camera. The width of a pixel of the image sensor 90 is substantially equal to a product of the illumination width W on the wafer 1 and the horizontal magnification M of the detection optical system 41.

As a result, a confocal optical system is formed in the X direction. This makes it possible to inhibit the detection of light scattered from a pattern 8 in a low layer of film layered on the wafer 1. The pattern formed on the wafer 1 varies in direction, periodicity, and pitch. The sensitivity of the defect inspection apparatus can be effectively increased by suppressing or blocking scattered light and diffracted light from a normal pattern and detecting only the scattered light coming from a defect. Therefore, an effective method is to change the light shielding scheme of a spatial filter in accordance with the pattern whose image is detected.

However, when a TDI (Time Delay Integration) sensor or other similar sensor having two-dimensionally arrayed light-receiving pixels is used, an appropriate light shielding scheme cannot be set at a boundary between two portions that differ in pattern periodicity or pitch in a stage scanning direction X. Meanwhile, when the configuration shown in FIGS. 2(a) and 2(b) is used, only one pixel is to be detected in a wafer scanning direction. Therefore, when the light shielding scheme of the spatial modulators is rapidly changed, appropriate spatial filtering can be performed even at a pattern boundary.

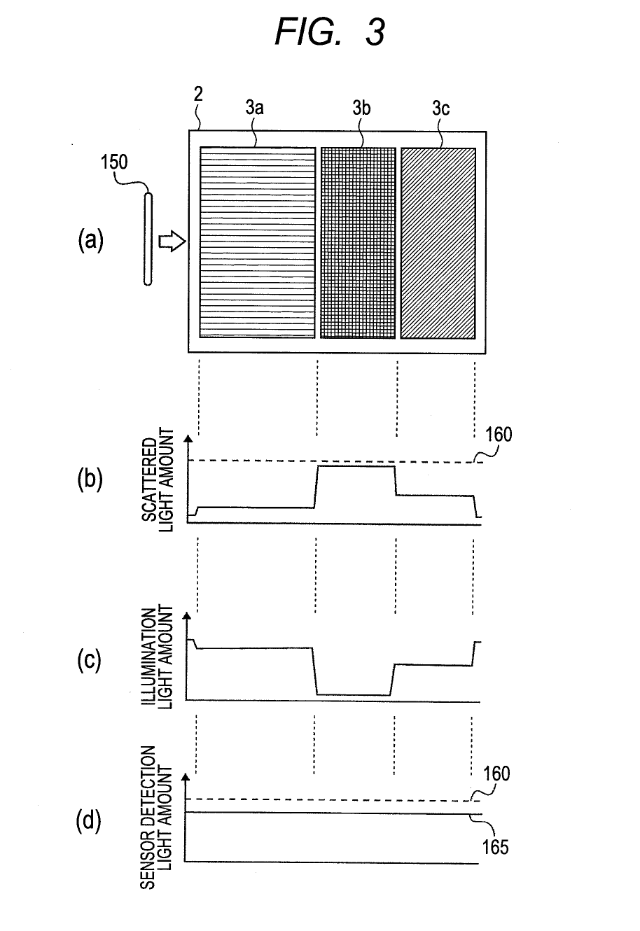

FIG. 3(a) shows a concept in which the electrooptical element 7 shown in FIG. 1 changes the amount of illumination light at a high speed.

Patterns having the same design are repeatedly formed on the wafer so that the patterns formed on individual dies 2 have the same design. Pattern areas 3a, 3b, 3c, which differ in pattern direction, pattern periodicity, and pitch of such periodicity, are formed within a die 2. In these pattern areas, the amount of detected pattern scattered light varies. Therefore, when illumination is to be provided in such a manner as to avoid image saturation, a pattern area where the amount of scattered light is relatively large within the die 2 needs to be set for an illumination light amount that does not cause saturation. If, in this instance, microscopic defects to be detected provide a small amount of detected scattered light, it is difficult to detect such defects due to a small illumination light amount. For example, FIG. 3(b) shows the amount of scattered light that is detected when the illumination light amount is fixed.

Referring to FIG. 3(b), the illumination light amount is set so that the amount of light detected from the pattern area 3b where the amount of detected scattered light is large is smaller than a sensor saturation light amount 160. As shown in FIG. 3(c), control is exercised to set a small illumination light amount for an area where the detected scattered light amount is large and a large illumination light amount for an area where the detected scattered light amount is small. Consequently, a sensor detection light amount 165 can be detected at the same level as the sensor saturation light amount 160 as shown in FIG. 3(d). This makes it possible to increase the illumination light amount for the area 3a and area 3c shown in FIG. 3(b). As a result, defect detection sensitivity for these areas can be increased.

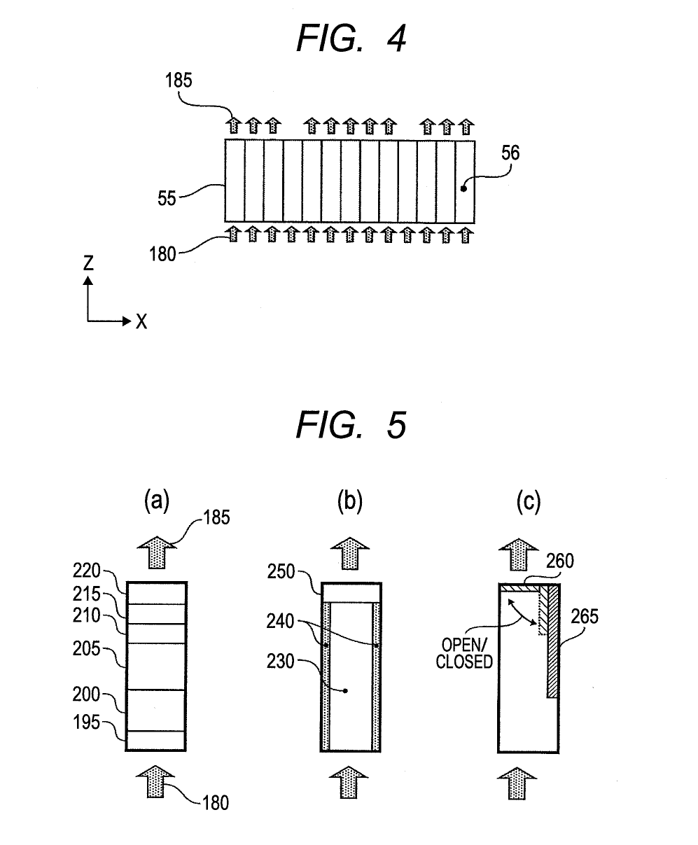

Functions of the spatial modulators 55a, 55b shown in FIG. 1 are illustrated in FIG. 4 (XZ cross-sectional view). The transmission spatial modulators 55 are configured so that individual elements 56 are two-dimensionally arrayed in the XY direction to control transmission, dimming, and light shielding. Incident light can be subjected to transmission/dimming/light shielding control on an individual element basis. When light is transmitted through the spatial modulators 55, the light is transmitted through specified elements only. Three different structures of the elements of the spatial modulators are shown in FIGS. 5(a) to 5(c). FIG. 5(a) shows a spatial modulator that uses a liquid crystal. Light 180 incident on a liquid-crystal filter is linearly polarized by the PBS 50 shown in FIG. 1. A TFT (Thin Film Transistor) substrate 195 controls a voltage applied to a transparent electrode 215 to change an array of liquid crystals 205 enclosed between two alignment films 200, 210. The transmittance 185 of filter transmission light, which is transmitted through a polarizing plate 220, can be controlled in accordance with the array of the liquid crystals 205. FIG. 5(b) shows the structure of one element that utilizes the electrooptical effect. The incident light 180 falls on a birefringent member 230 that is made, for instance, of LiNbO₃ or PLZT to produce the electrooptical effect. The direction of oscillation of linearly polarized incident light can be controlled in accordance with the voltage applied to the electrode formed for each element in order to change the transmittance of a polarizing plate 250.

FIG. 5(c) shows the structure of one element that uses the MEMS. A shield section 260 and an electrostatic force generation section 265 are formed in the element. An employed mechanism is such that applying a predetermined voltage to the shield section 260 and the electrostatic force generation section 265 causes the shield section 260 to turn over toward the electrostatic force generation section 265 due to the action of capacitance. Consequently, controlling the voltage applied to the shield section 260 and the electrostatic force generation section 265 makes it possible to provide, on the element basis, control over incident light transmission/shielding by opening or closing the shield section.

As described above, the illumination light amount is adjusted by using a combination of the electrooptical element 7 and the PBS 50, which are disposed in the illumination system, whereas the light shielding scheme based on spatial filtering is rapidly changed by using the spatial modulators, which include a liquid crystal and an electrooptical element or the MEMS. In this instance, an appropriate light shielding scheme is applied to each of the patterns arrayed in the X direction by positioning a light receptor for the image sensor so as to thin-line illuminate the wafer and establish a confocal detection system in the X direction. This makes it possible to suppress the scattered light from patterns and defects in a low layer of the wafer 1 and effectively reduce the possibility of detecting low-layer patterns and defects.

### Second Embodiment

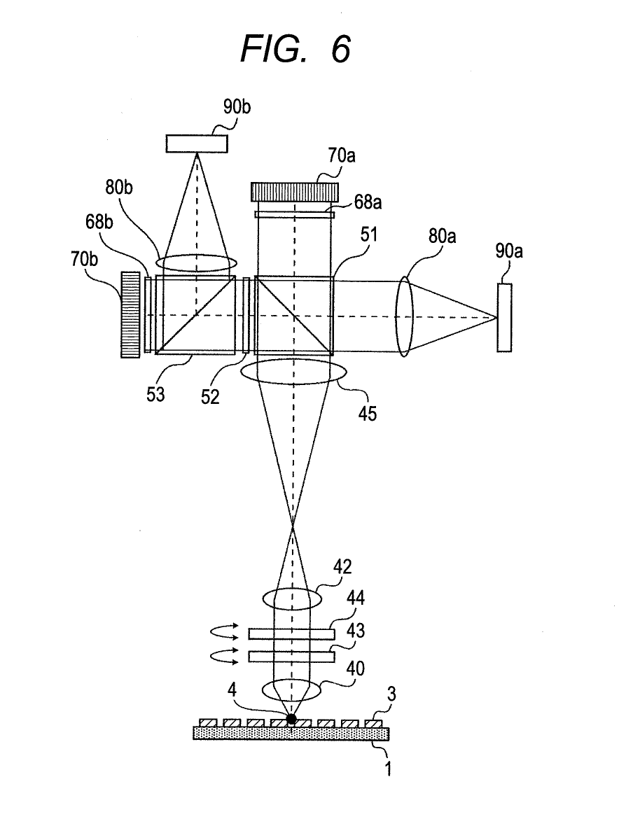

In the first embodiment, it is assumed that transmission spatial modulators are used. In a second embodiment of the present invention, on the other hand, it is assumed that reflection spatial modulators are used. FIG. 6 shows the configuration of an optical system with reflection spatial modulators that use a two-dimensional array DMD (Digital Micro-mirror Device). An objective lens 40 is used to capture light that is scattered from a pattern 3 on the wafer 1 and a defect 4. The captured light is transmitted through a half-wavelength plate 43 with a rotation mechanism and a quarter-wavelength plate 44 with a rotation mechanism, and incident on a PBS 51 through lenses 42, 45. Linearly polarized light (P-polarized component) transmitted through the PBS 51 is transmitted through a quarter-wavelength plate 68a and circularly polarized. The circularly polarized light is incident on a reflection spatial modulator 70a that is disposed at a conjugated position of a Fourier transform plane. The spatial modulator 70a is configured so that electrical control is exercised to tilt individual mirror surfaces. When diffracted light from a pattern on the wafer is to be blocked, mirrors are tilted to move the diffracted light out of an optical path for light shielding purposes. As for light to be detected, the mirrors are not tilted. More specifically, the mirror surfaces are set so that the light is perpendicularly incident on the mirrors. This ensures that the light is reflected to travel in a reverse direction through the same optical path as for the incident light. After being transmitted again through the quarter-wavelength plate 68a, the light reflects from a polarizing beam splitter 15 as S-polarized light. The reflected light travels through an imaging lens 80a and forms a scattered image on an image sensor 90a.

Meanwhile, linearly polarized light (S-polarized component) reflected from the PBS 51 is transmitted through a half-wavelength plate 52, directed toward a second PBS 53 as P-polarized light, and transmitted through the second PBS 53. The transmitted light is circularly polarized by a quarter-wavelength plate 68b. The light that is not to be detected by a spatial modulator 70b is reflected away from the optical path for light shielding purposes. The other light, which is detected, is transmitted again through the quarter-wavelength plate 68b, directed toward the PBS 53 as S-polarized light, and reflected from the PBS 53. The reflected light travels through an imaging lens 80b and forms a scattered image on an image sensor 90b.

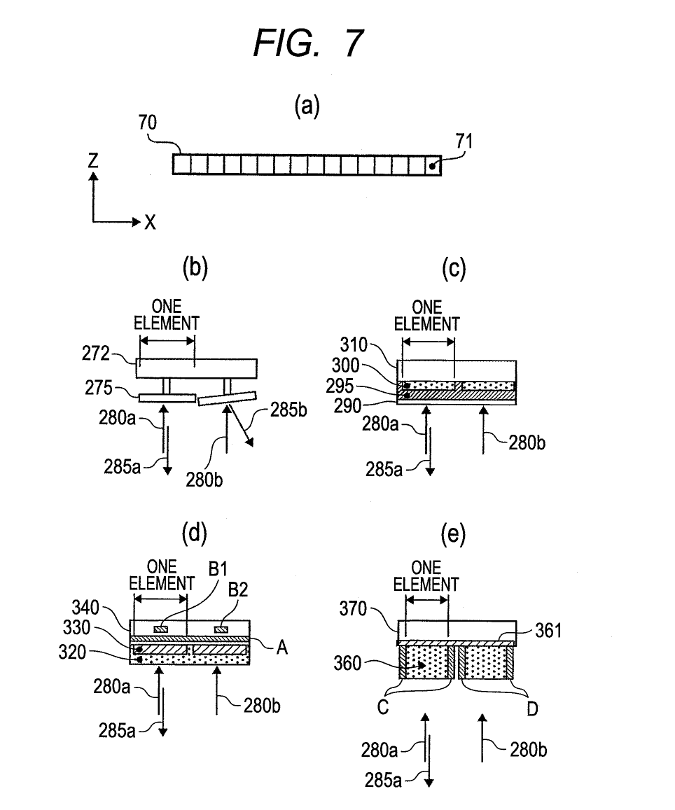

FIGS. 7(a) to 7(e) show the structure of the reflection spatial modulators 70. FIG. 7(a) is an XZ cross-sectional view of the reflection spatial modulators 70. A plurality of reflection spatial modulation elements are two-dimensionally formed in the XY plane of the reflection spatial modulators 70. Four different structures of the reflection spatial modulators 70 are shown in FIGS. 7(b) to 7(e) (two elements are shown). FIG. 7(b) shows a structure in which the MEMS described with reference to FIG. 6 are used. A spatial modulator 270 is configured so that a mirror 275 is formed on a substrate 272. Electrical control is exercised so that each mirror surface can be tilted. As for light 280a to be detected, the mirror 275 is disposed so that the light is perpendicularly incident on the mirror. This ensures that reflected light 185a travels in a reverse direction through the same optical path as for the incident light.

Meanwhile, as for light 280b that is not to be detected, the mirror is tilted so that the light 285b is reflected away from the optical path for light shielding purposes. FIG. 7(c) shows a structure of the reflection spatial modulators in which a liquid crystal is used. Incident light 28a falls on the liquid crystal 295. The light is perpendicularly incident on a film that serves as a reflection surface and an electrode, and then specularly reflected. Light to be detected is electrically controlled so that the angle of optical rotation provided by a round trip to the liquid crystal 295 is 90 degrees (a direction orthogonal to the oscillation direction of electric field vector of incident light). Meanwhile, light to be blocked is electrically controlled so that the angle of optical rotation provided by a round trip to the liquid crystal 295 is 0 degrees (a direction parallel to the oscillation direction of electric field vector of incident light). FIG. 7(d) shows a structure in which a magnetooptical element is used. Incident light 280a falls on a garnet film or other magnetic film 330 formed on a transparent glass substrate. As for light to be detected, an electrical current flows to wires A and B1 so that a Faraday rotation amount received upon reflection from the magnetic film is 90 degrees (a direction orthogonal to the oscillation direction of electric field vector of incident light). Meanwhile, as for light that is not to be detected, an electrical current flows to wires A and B2 so that a Faraday rotation amount received upon reflection from the magnetic film is 0 degrees (a direction parallel to the oscillation direction of electric field vector of incident light). FIG. 7(e) shows a structure in which an electrooptical element is used. The incident light 280a falls on a birefringent member 360 that is made, for instance, of LiNbO₃ or PLZT to produce the electrooptical effect. The light is transmitted through the birefringent member 360, reflected from a reflection film 361 formed on a substrate 370, and directed back to the birefringent member 360 to make a round trip.

As for light to be detected 280a, a voltage is applied to electrode C so that the amount of electric field vector rotation provided by a round trip to the birefringent member 360 is 90 degrees (a direction orthogonal to the oscillation direction of electric field vector of incident light). Meanwhile, as for light to be blocked, a voltage is applied to electrode D so that the amount of electric field vector rotation provided by a round trip to the birefringent member 360 is 0 degrees (a direction parallel to the oscillation direction of electric field vector of incident light).

### Third Embodiment

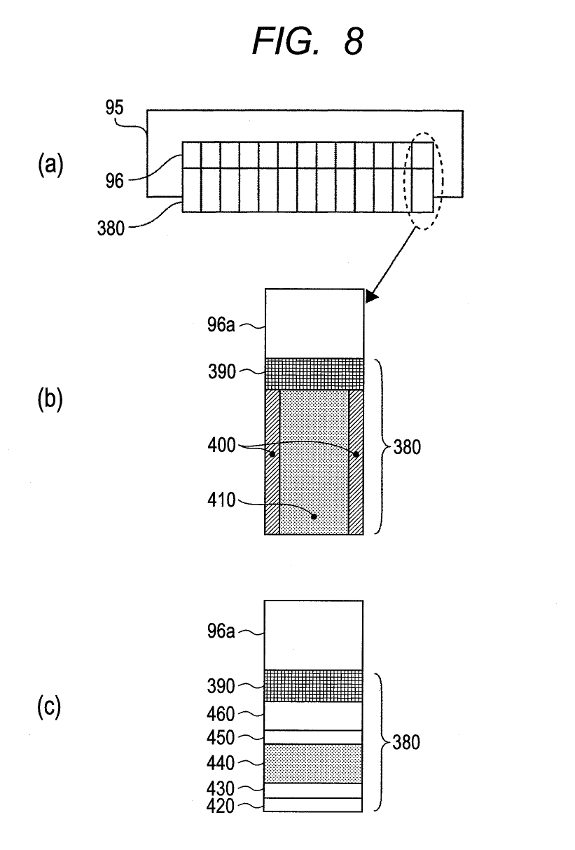

In the first and second embodiments, it is assumed that the employed configuration simultaneously detects two types of images, which are based on the polarization of scattered light. A third embodiment of the present invention will now be described with reference to a system shown in FIG. 8(a). While elements shown in FIGS. 5 and 7 are disposed immediately before an image sensor to detect pixels, the system detects a polarized light image that varies from one pixel to another. Here, it is assumed that a detection optical path does not use a PBS, and that MEMS or other spatial modulators that do not use polarized light (an example is shown in FIG. 5(c)) are employed. An array of light receptors 96 and an array of optical modulators 380 are formed in an image sensor 95. In the XY cross-sectional view, the arrays may be one-dimensionally disposed in the Y direction or two-dimensionally disposed in the XY direction.

One of the aforementioned elements is shown in FIG. 8(b). Incident light falls on a birefringent member 410 that is made, for instance, of LiNbO₃ or PLZT to produce the electrooptical effect. The light is transmitted through the birefringent member 410, and incident on a polarizing plate 390 that is made, for instance, of a wire grid or a photonic crystal. Although the transmission axis of the polarizing plate 390 is oriented in a particular direction, the voltage applied to an electrode 400 is controlled on an individual pixel basis so that the electric field vector to be detected is aligned with the transmission axis of the polarizing plate 390. FIG. 8(c) shows one of the elements included in a configuration that uses a liquid crystal. Incident light is transmitted through a transparent electrode 420, an alignment film 430, a liquid crystal 440, an alignment film 450, a TFT substrate 460, and the polarizing plate 390 so that only a component aligned with the transmission axis of the polarizing plate 390 is incident on a light receptor 96a and detected. When this configuration is employed to control the voltage applied to the transparent electrode, the polarized light to be detected can be aligned with the transmission axis of the polarizing plate 390. When the above-described configuration is used, the polarization direction of the scattered light to be detected can be selected on an individual pixel basis.

In the above-described embodiment, polarized light placed under any condition is detected per pixel. Patterns and defects have complex scattered light polarization properties. Therefore, simultaneous detection of images placed under a plurality of polarization conditions may result in an increase in the defect capture rate. The defect capture rate can be increased by dividing one pixel of the image sensor into 2×2 sub-pixels and providing the 2×2 sub-pixels respectively with polarizing plates having transmission axes that differ by 45 degrees. The 2×2 sub-pixels may be regarded as one pixel to grasp the polarization state of each pixel and perform a die comparison process by handling the polarization state as a feature amount.

In the past, the amount of detected light (brightness) was checked to perform the die comparison process, and an adequate S/N ratio could not be achieved for microscopic defects when the die comparison process was based on the difference in brightness. However, the use of the method described above in connection with the present embodiment makes it possible to achieve a high S/N ratio for microscopic defects. In particular, when the transmitted light polarization properties of a common wire grid polarizer are considered, it is obvious that microscopic defects and patterns have scattered light polarization properties.

### Fourth Embodiment

Detected scattered light may be high in intensity depending on a pattern on the wafer. In some cases, therefore, it is necessary that the amount of illumination light be set to be low in order to inhibit an image detected by the image sensor from saturating. This may decrease the detection sensitivity to microscopic defects. To address this problem, the optical system configured as shown in FIGS. 1 and 6 may utilize the image sensor shown in FIGS. 8(a) to 8(c). The third embodiment is described in connection with the method of detecting an image when the polarization state varies from one pixel to another. A fourth embodiment of the present invention will now be described to explain about a method of adjusting the amount of light to be detected on an individual pixel basis. In FIGS. 1 and 6, the light incident on the image sensor is linearly polarized because the PBS is used.

A birefringent element and a liquid crystal are disposed on an incidence plane of the image sensor shown in FIGS. 8(a) to 8(c). Linearly polarized incident light can be rotated in any one direction by controlling the voltage applied to the birefringent element and liquid crystal on an individual pixel basis. Therefore, when a large amount of scattered light is to be detected, control is exercised to rotate the linearly polarized light in a direction orthogonal to the transmission axis of the polarizing plate 390, which is disposed immediately before a light-receiving surface. When, in contrast, a small amount of scattered light is to be detected, control is exercised to align the linearly polarized light with the transmission axis of the polarizing plate 390. This makes it possible to illuminate the wafer at an illumination light intensity at which defects to be detected can be detected, and reduce the amount of detection light for an area where image saturation is likely to occur.

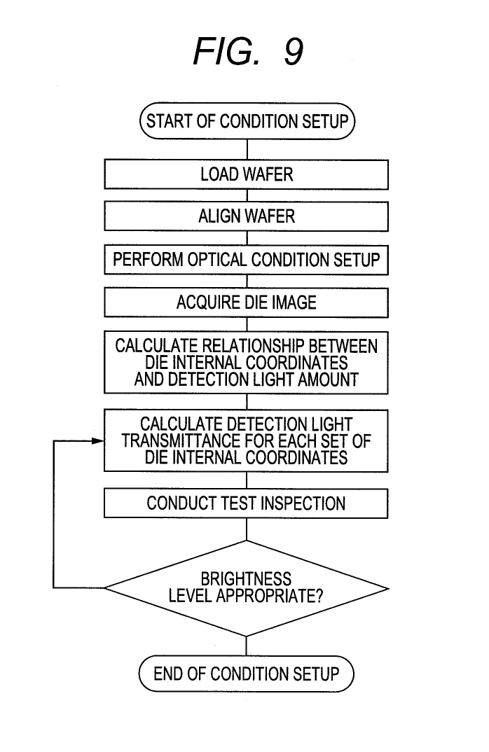

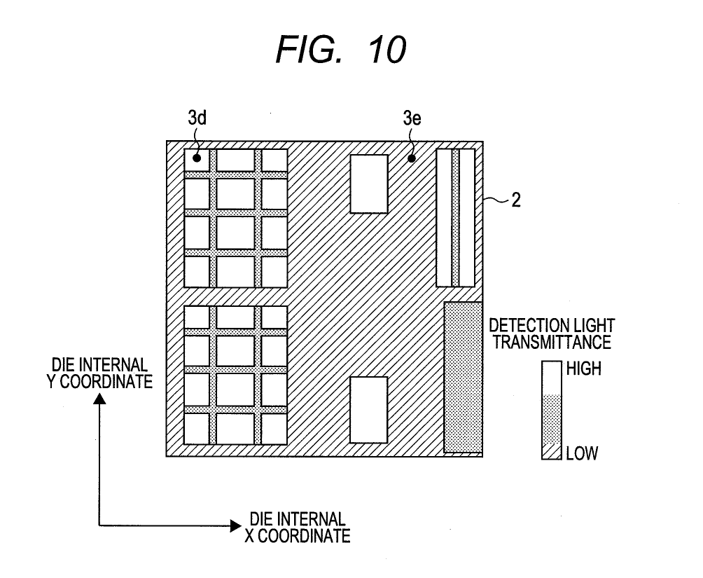

An inspection method based on the above-described method of controlling the detection light amount on an individual pixel basis will now be described with reference to an inspection flowchart of FIG. 9. First of all, it is necessary to perform condition setup (perform a prescan) for determining optical conditions and image processing conditions for the purpose of inspecting a target wafer. The first step is to load the target wafer into the defect inspection apparatus, irradiate the wafer with light, measure the resulting reflected light with a measurement section, effect θ alignment between a stage scanning direction and a wafer pattern, and perform XY coordinate origin setup. The next step is to perform condition setup concerning, for instance, the elevation angle and polarization of illumination light, and acquire a detected die image. An illumination light amount calculation section then calculates the relationship between each set of X and Y die internal coordinates and a detection light amount. The next step is to calculate an appropriate detection light transmittance value for each set of coordinates from the detection light amount for each set of coordinates. Subsequently, a test inspection is conducted so that the calculated transmittance for each set of coordinates is actually applied to check an image brightness level and sensitivity. If the transmittance for each set of coordinates is not appropriate, transmittance setup is repeatedly performed until the image brightness level and sensitivity are appropriate.

FIG. 10 is a schematic diagram illustrating the detection light transmittance for each set of die internal coordinates. As for a memory mat section, a relatively dark image results because diffracted light is blocked by spatial modulators. For such an area, a high detection light transmittance setting is employed. In contrast, as for a nonperiodic logic wiring area where the amount of detected light is large, a low detection light transmittance setting is employed. Using the above-described scheme makes it possible to ensure that the memory mat section is substantially equal to the logic wiring area in image brightness level.

The configurations, functions, and image processing schemes described in connection with the foregoing embodiments may be variously combined. It is obvious that such combinations may be employed without departing from the scope of the present invention.

### DESCRIPTION OF REFERENCE NUMERALS

1 . . . Wafer
2 . . . Die
3 . . . Pattern
4 . . . Defect
5 . . . Laser
6 . . . XYZθ stage
7 . . . Electrooptical element
10 . . . Beam expander
22 . . . Illumination light
30 . . . Illuminated area
40 . . . Objective lens
43 . . . Half-wavelength plate with rotation mechanism
44 . . . Quarter-wavelength plate with rotation mechanism
50 . . . Beam splitter
55 . . . Spatial modulator
70 . . . Reflection spatial modulator
80 . . . Imaging lens
90 . . . Image sensor
100 . . . Image processing section
110 . . . Operation section
120 . . . Mechanism control section
130 . . . Height detection section
205 . . . Liquid crystal
230 . . . Electrooptical element
265 . . . MEMS

1. A defect inspection apparatus for detecting a defect on a surface of a sample on which a pattern is formed, the defect inspection apparatus comprising:
an illumination optical system that includes a light source section for emitting light and an illumination section for irradiating the sample with the light at a predetermined angle with respect to a normal extending from the sample surface;
light capture means for capturing scattered light or diffracted light emitted from an area illuminated by the light incident on the sample;
polarizing-and-splitting means for receiving the light captured by the light capture means and polarizing and splitting the light into a first direction and a second direction orthogonal to the first direction; and
light shielding means for blocking part of the split light in one or more optical paths of the polarized and split light.

2. The defect inspection apparatus according to claim 1, further comprising:
image detection means for detecting an image with an image sensor that is disposed on each imaging plane on which the polarized and split light is incident; and
an image processing section for performing a comparison process on a feature amount of the image obtained from each imaging plane to identify a defect candidate.

3. The defect inspection apparatus according to claim 2, wherein the illuminated area is moved by a scanning section that scans the sample in a horizontal plane.

4. The defect inspection apparatus according to claim 1, wherein the light shielding means is a spatial modulator that uses a liquid crystal, an electrooptical element, a magnetooptical element, or MEMS.

5. The defect inspection apparatus according to claim 4, wherein the light shielding means is an array of spatial modulation elements having a structure through which the polarized and split light is transmitted.

6. The defect inspection apparatus according to claim 4, wherein the light shielding means is an array of spatial modulation elements having a structure from which the polarized and split light is reflected.

7. A defect inspection apparatus for detecting a defect on a surface of a sample on which a pattern is formed, the defect inspection apparatus comprising:
an illumination optical system that includes a light source section for emitting light and an illumination section for irradiating the sample with the light at a predetermined angle with respect to a normal extending from the sample surface;
an objective lens for capturing scattered light or diffracted light emitted from an area illuminated by the light incident on the sample;
image detection means for detecting an image with an image sensor that is disposed on an imaging plane formed by the objective lens and provided with an element capable of modulating a light amount on an individual pixel basis; and
an image processing section for performing a comparison process on an image feature amount obtained from the imaging plane to identify a defect candidate.

8. The defect inspection apparatus according to claim 7, wherein the element capable of modulating a light amount is an element capable of modulating a transmittance on an individual pixel basis.

9. The defect inspection apparatus according to claim 7, wherein the element capable of modulating a light amount is an analyzer capable of modulating a transmission axis.

10. The defect inspection apparatus according to claim 8, wherein the image sensor is provided, on a light-receiving surface thereof, with a polarizer made of a wire grid or of a photonic crystal.

11. A defect inspection method for detecting a defect on a surface of a sample on which a pattern is formed, the defect inspection method comprising the steps of:
illuminating the sample with linear illumination light at an oblique angle from a normal extending from the sample while scanning the sample in a horizontal plane;
allowing an objective lens to capture scattered light and diffracted light emitted from an area illuminated by the illumination light incident on the sample and form an image on an imaging plane;
disposing an image sensor on the imaging plane, the image sensor having an element capable of modulating a light amount on an individual pixel basis, and allowing the image sensor to detect the image; and
performing a comparison process on a feature amount obtained from the detected image to identify a defect candidate.

12. The defect inspection method according to claim 11, wherein the element capable of modulating a light amount is an element capable of modulating a transmittance on an individual pixel basis.

13. The defect inspection method according to claim 11, wherein the element capable of modulating a light amount is an analyzer capable of modulating a transmission axis.
